(19) United States
(12) Patent Application Publication
(10) Pub. No.: US 2005/0010907 A1
(43) Pub. Date: Jan. 13, 2005

(54) Method and apparatus for reducing a program size while maintaining branching time properties and automated checking of such reduced programs

(76) Inventor: Kedar Sharadchandra Namjoshi, Basking Ridge, NJ (US)

Correspondence Address: Ryan, Mason & Lewis, LLP, Suite 205, 1300 Post Road, Fairfield, CT, 06824, US

(21) Appl. No.: 10/614,618

(22) Filed: Jul. 7, 2003

(51) Int. Cl. G06F 9/44

(52) U.S. Cl. 717/124

(57) ABSTRACT

A method and apparatus are provided a method and apparatus for reducing a program that preserves branching time properties, including existential and universal aspects. An alternating transition system (ATS) is abstracted, formed by a product of a program, M, with an alternating tree automaton, A, for a property, f. The disclosed program abstraction method generates the abstract program and an altered version of the branching time property, f. An automated program check, such as a model check, is performed on the abstract program for the altered branching time property. The invention provides semantic completeness: i.e., whenever a program satisfies a property, this can be shown using a finite-state abstract ATS produced by the method. Choice predicates can be employed to help resolve nondeterminism at OR states, and rank functions can be employed to help preserve progress properties.

### FIELD OF THE INVENTION

The present invention relates generally to automated program checking techniques, and more particularly, to methods and apparatus for reducing the size of programs prior to such automated program checking techniques.

### BACKGROUND OF THE INVENTION

Software programs can often be difficult to test or verify. In order to efficiently and effectively evaluate software programs, it is often necessary to reduce the size of the program, for example, using abstraction techniques. Most current abstraction methods preserve universal temporal properties, such as those expressible in linear temporal logic (LTL) and Universal Computation Tree Logic (ACTL). In several settings, there is a need for methods that preserve branching time properties, including mixed existential and universal branching time properties. For example, branching time properties must be maintained to analyze programs with unresolved non-determinism, or to analyze process-environment interaction. See, for example, R. Alur et al., “Alternating-Time Temporal Logic,” COMPOS, Vol. 1536 of Lecture Notes in Computer Science (LNCS), (1997).

Methods for universal properties, such as those described in R. Milner, “An Algebraic Definition of Simulation Between Programs,” 2d Int'l Joint Committee on Artificial Intelligence (IJCAI) (1971), rely on establishing a simulation relation between the concrete program to an abstract program. Unfortunately, to preserve all branching time properties in a similar manner requires a bisimulation between the two programs (which is too restrictive). A need therefore exists for a method and apparatus for reducing a program that simultaneously preserves the existential and universal aspects of a branching time property, without relying on bisimulation.

### SUMMARY OF THE INVENTION

Generally, a method and apparatus are provided a method and apparatus for reducing a program that preserves branching time properties. In particular, the invention simultaneously preserves the existential and universal aspects of a branching time property, and does not rely on bisimulation. The disclosed program abstraction method abstracts an alternating transition system (ATS) formed by a product M×A of a program, M, with an alternating tree automaton, A, for a property. An abstract domain contains a set of abstract values that generalize possible real states of the program, M, and abstract relations relate states of the program, M, to the abstract domain. The program abstraction method generates the abstract program, \overline{M×A}, and an altered version of the branching time property, f. An automated program check, such as a model check, is performed on the abstract program, \overline{M×A} for the altered branching time property (whether a first player has a winning strategy in said abstract program, \overline{M×A}).

A set of states, S′, in the abstract program are defined as S′=\overline{S}×Q. where S is a set of states in said program, M, and Q is a finite set of states. OR states in the set of states, S′, are those states where δ(q, true) has the form q₁ [symbol] q₂ or [symbol] a [symbol] q₁, and all other states are AND states, where q are individual states and δ is a transition relation of the automaton A between states. An abstract state (t, \hat{q}) is in a subset of initial states, I′, of the abstract program if there exists s∈I for which sξ_{\hat{q}}t, where s is an individual state, I is a subset of initial states, I, of the program, M, and ξ\hat{q} is one of the abstract relations [i.e., the relation corresponding to the initial automaton state ξ\hat{q}. For an abstract AND state (t, q), the transition ((t, q); (t′,q′)) is in an abstract transition relation, R′, if there exists a concrete state (s, q) and a successor (s′,q′) that are related to (t, q); (t′,q′) respectively. For an abstract OR state (t, q), the transition ((t, q); (t′, q′)) is in an abstract transition relation, R′, only if for every (s, q) which is related to (t, q), there exists a successor (s′,q′) which is related to (t′,q′). The product ATS M×A is abstracted by weakening said transition relations at AND states. The product ATS M×A is abstracted by strengthening said transition relations at OR states.

The invention provides semantic completeness: i.e., whenever a program satisfies a property, this can be shown using a finite-state abstract ATS produced by the method. In one variation, choice predicates are employed to help resolve nondeterminism at OR states, and rank functions are used to help preserve progress properties. When this result is specialized to predicate abstraction, exact characterizations of the types of properties provable with these methods are obtained.

A more complete understanding of the present invention, as well as further features and advantages of the present invention, will be obtained by reference to the following detailed description and drawings.

### BRIEF DESCRIPTION OF THE DRAWINGS

FIG. 1 illustrates a program abstraction method incorporating features of the present invention;

FIG. 2 is a flow chart of an exemplary embodiment of the program abstraction method of FIG. 1;

FIG. 3 illustrates a portion of a product ATS M×A;

FIG. 4 illustrates an abstract ATS of the program, M, in FIG. 3;

FIG. 5 illustrates an abstract ATS of the program, M, following an augmented abstraction in accordance with one embodiment of the invention; and

FIG. 6 illustrates an abstract ATS of the program, M, derived from a completeness proof.

### DETAILED DESCRIPTION

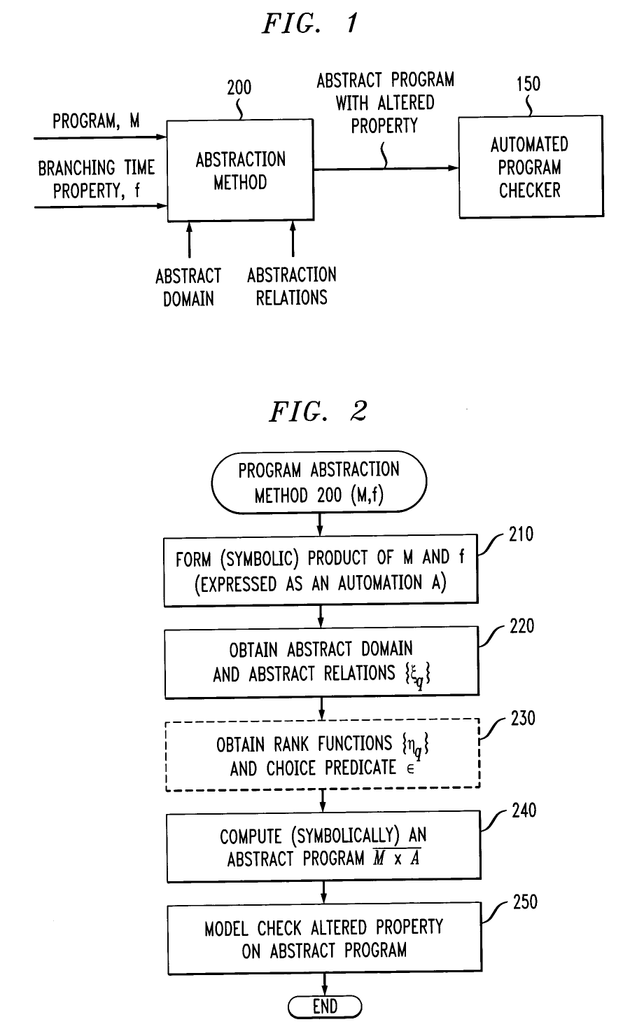

As shown in FIG. 1, the present invention provides a program abstraction method 200, discussed below in conjunction with FIG. 2, that abstracts a program, M, while preserving one or more branching time properties, f, and in particular, while simultaneously preserving the existential and universal aspects of a branching time property. Generally, the program abstraction method 200 abstracts an alternating transition system (ATS) formed by the product of a program with an alternating tree automaton for a property. As discussed further below, the program abstraction method 200 also receives a user-specified abstract domain and abstract relations, and generates an abstract program with an altered property. The abstract program with an altered property is then checked by an automated program checker 150, such as a model checker.

### Automated Program Checking Concepts

As the verification problem is generally undecidable, even for invariance properties, no algorithm is known that can always construct a finite-state abstract program precise enough to prove that a concrete program satisfies a property. Thus, semantic completeness is typically considered. Semantic completeness considers if a program satisfies a property and whether this fact can be shown using a finite state abstract program constructed by the method, ignoring computability issues. It has been shown that simulation-based abstraction must be augmented with fairness to be complete for LTL progress properties, such as termination. The fairness constraints serve to abstractly represent such termination requirements.

This completeness result does not, however, apply to all universal properties, such as ACTL logics. Technically, the problem is that disjunction of temporal state formulas, as in AX(p) [symbol] AX( [symbol] p ), cannot be represented in LTL. Thus, for branching time properties, there is a distinction between AND and OR branching, in addition to the invariance-progress distinction.

A labeled transition system (LTS) M (i.e., the program) over a fixed action set Σ and a set of atomic propositions, AP, is defined by a tuple (S. I, R, L), where S is a set of states, I is the subset of initial states, R⊂S×S×S is a transition relation, and L: S→2^{AP} is a labeling of states with atomic propositions. It is assumed that the relation R is total over Σ; i.e., for each a in Σ, every state has an a-successor.

An alternating tree automaton (ATA) over Σ and AP is given by a tuple (Q∪{tt,ff}\hat{q},δ,F), where Q is a finite set of states, \hat{q} in Q is the initial state, δ is a transition relation, and F=(F₀, . . . , F₂ₙ) is a partition of Q, called the parity acceptance condition (see, E. A. Emerson and C. S. Jutla, “Tree Automata, mu-Calculus and Determinacy (Extended Abstract),” Foundations Of Computer Science (FOCS), (1991), incorporated by reference herein). A sequence of automaton states is accepted if the least index i such that a state from Fᵢ occurs infinitely often on the sequence is even. The transition relation δ maps an automaton state, and a predicate on AP to one of: ff (an error state); tt (an accept state); q₁\hat{ }q₂ (forking off automaton copies in state q₁ and q₂); q₁ [symbol] q₂ (choosing to proceed in either state q₁ or state q₂); (a)q₁ (continuing in q₁ for some a-successor); [a] q₁ (continuing in q₁ for every a-successor).

An LTS M equal to (S, I, R, L) satisfies a property given by an ATA A equal to (Q, \hat{q}, δ, F) if and only if player I has a winning strategy in an infinite, two player game (see, E. A. Emerson and C. S. Jutla). In this game, a configuration is a pair of a computation tree node of M labeled by a state s, and an automaton state q. A configuration labeled (s, q) is a win for player I if δ(q, L(s))=tt; it is a loss if δ(q, L(s))=ff. For other values of δ, player I picks the next move if and only if δ(q,L(s))=tt is either [symbol] a [symbol] q₁ or q₁ [symbol] q₂. Player I picks an a-successor for s for [symbol] a [symbol] q₁, or the choice of disjunct. Similarly, player II picks an a-successor for s for [a]q₁, or the choice of conjunct for q₁\hat{ }q₂. A play of the game is a win for player I if and only if the play either ends in a win for I, or it is infinite and the sequence of automaton states on it satisfies F. A strategy is a function mapping a partial play to the next move. Given strategies for players I and II, one can generate the possible plays. Finally, the LTS satisfies the automaton property if and only if player I has a winning strategy (one for which every generated play is a win for player I) for the game played on the computation tree of the LTS from the initial configuration labeled (ŝ, \hat{q}).

Every closed formula of the μ-calculus (see, D. Kozen, “Results on the Propositional mu-Calculus,” International Colloquium on Automata, Languages and Programming (ICALP) (1982), incorporated by reference herein) can be translated in linear time to an equivalent ATA (as described by E. A. Emerson and C. S. Jutla). The transition relation of the automaton has the following simple form: each state has a single transition for the input predicate true, except for a transition to tt on predicate l; in which case, there is another transition to ff on [symbol] l.

An alternating transition system (ATS) over a set Γ of state labels is defined by a tuple (S, I, R. L), where S, the set of states, is partitioned into AND and OR subsets, I is a set of initial states, R⊂S×S is the transition relation, and L: S→Γ the state labeling.

The model checking problem is to determine whether M satisfies A at all initial states, and is written as M [symbol] A. This can be determined using a product ATS, M×A, defined by (S, I, R, L), where S=S_{M}×Q_{A},I=I_{M}×{\hat{q}_{A}}, and L:(s,q)→q. R((s,q),(s′,q′)) holds based on the value of δ_{A}(q,l), as follows: (i)ff, tt: q′=δ_{A}(q,l)\hat{ }s′=s\hat{ }l(s), (ii) q₁\hat{ }q₂,q₁ [symbol] q₂: q′∈{q₁,q₂}\hat{ }s′=s as 1≡true, and (iii) [symbol] a [symbol] q₁,[a]q₁:q′=q₁\hat{ }R_{M}(s,a,s′), as 1≡true. A state is an OR state if δ_{A}(q,l) is either q₁ [symbol] q₂ or [symbol] a [symbol] q₁, and an AND state otherwise. In E. A. Emerson, C. S. Jutla, and A. P. Sistla, “On Model-Checking for Fragments of μ-Calculus, CAV, 1993, it is shown that M satisfies A if and only if player I has a winning strategy in the game graph defined by M×A, where player I makes choices at OR states, and player II at AND states, and that this can be determined by model checking, if this is the case, M×A is said to be feasible.

### Abstraction Method

As previously indicated, the program abstraction method 200 is defined for the product alternating transition system (ATS). Soundness is shown by constructing a valid concrete proof of correctness given the feasibility of the abstract ATS. This construction also indicates why augmentation with choice predicates and rank functions is needed in general, as discussed further below in a section entitled “Abstract Transition Relation Using Rank Functions and Choice Predicates.” In the following, let M=(S, I, R, L) be an LTS over Σ and AP, and let A=(Q,\hat{q},δ,F), where F=(F₀, . . . , F₂ₙ) (for some n), be an ATA over Σ and AP. Let M×A be the product ATS, constructed as shown earlier.

FIG. 2 is a flow chart describing an exemplary implementation of the program abstraction method 200 of FIG. 1. The program abstraction method 200 is initiated with the program, M, to be abstracted, as well as the branching time property, f, to be preserved and an automaton, A, for f. Initially, the (symbolic) product of M and f are formed during step 210, in the manner discussed above.

Thereafter, the user-specified abstract domain, \overline{S}, and a set of left-total abstraction relations {ξₜₜ|q∈Q} are obtained during step 220, where each ξ_{q}⊂S×\overline{S}. The abstract domain is a set of values to generalize the possible real values of the program. The abstraction relations relate the real program states to the abstract domain. ξₜₜ and ξ_{ff} are defined to be S×\overline{S}, and note that (s, q) is related to (t, q) if and only if Sξ_{q}t holds. It is noted that step 230 is an optional step that augments the program abstraction method 200 with choice predicates and rank functions and is discussed further below in a section entitled “Abstract Transition Relation Using Rank Functions and Choice Predicates.”

The ATS M×A is abstracted during step 240 by weakening its transition relation at AND states (thus permitting more behavior), and strengthening it at OR states (thus restricting the behavior). The result of step 240 is an abstract ATS, denoted by \overline{M×A}. The abstract ATS is given by (S′,I′,R′,L′). The abstract set of states, S′=\overline{S}×Q. The abstract OR states are those where δ(q,true) has the form q₁ [symbol] q₂ or [symbol] a [symbol] q₁, all others are AND states. Thus, related concrete and abstract states have the same AND/OR tag. The abstract state (t,\hat{q}) is in I′ if there exists s∈I for which sξ_{\hat{q}}t. The abstract transition relation, R′, is given by (when rank functions and choice predicates are not employed):
For an abstract AND state (t, q), the transition ((t, q); (t′,q′)) is in R′ if there exists a concrete state (s, q) and a successor (s′,q′) that are related to (t, q); (t′,q′) respectively.
   R′((t,q),(t′,q′)) [symbol] (∃s:sξ_{q}t:(∃s′:s′ξ_{q′}t′:R((s,q),(s′,q′))))
For an abstract OR state (t, q), the transition ((t, q); (t′,q′)) is in R′ only if for every (s, q) which is related to (t, q), there exists a successor (s′,q′) which is related to (t′, q′).
   R′((t,q),(t′,q′)) [symbol] (∀s:sξ_{q}t:(∃s′:s′ξ_{q′}t′:R((s,q),(s′,q′))))
   The abstract labeling function L′ maps a state (t, q) to q.

Finally, an automated program check, such as a model checking, is performed for an altered property, discussed further below, on the abstract program during step 250.

It is noted that the program abstraction method 200 allows some flexibility in the definition of R′. If R′ is defined in a way that the implications become equivalences, then R′ is precise. This flexibility can be exploited in practice by doing approximate but faster calculations of a less precise R′. Precise abstractions are needed for completeness, though, as discussed below. It is further noted that the abstract ATS can be constructed by symbolic calculations, thus avoiding the explicit construction of M×A.

It can be shown (Theorem 0 (Soundness)) that for any LTS M and alternating tree automaton A, let \overline{M×A} be defined by the abstraction method, based on a set of abstraction relations {ξ_{q}}. Then, if \overline{M×A} is feasible, so is M×A. It can be shown that the relation a given by: (s, q) a (t, q′) if and only if q equals q′and sξ_{q}t is an alternating refinement relation that preserves the labeling (i.e., the automaton component). Therefore, any winning strategy for player I in \overline{M×A}, induces (through the refinement) a winning strategy on M×A. However, a different argument is used, showing how to construct a deductive proof that M satisfies A, given that M×A is feasible. This construction provides information useful for the completeness proof.

For a deductive proof, one needs: (i) for each automaton state q, an invariance predicate, φ_{q}, which is a subset of S, (ii) non-empty, well ordered sets W₁, . . . , Wₙ with associated partial orders ₁, . . . , ₙ (let W=w₁× . . . ×Wₙ, and let be the lexicographic well order defined on W from {ᵢ}), (iii) for each automaton state q, a partial rank function ρ_{q}: S→W (let ⁱ be the restriction of [symbol] to the first i components). For an automaton state q, the rank change predicate (a [symbol] _{q}b) holds either if q belongs to an odd indexed F₂ᵢ₋₁ and a [symbol] ⁱb, or if q is in an even indexed F₂ᵢ and aᵢb (this odd/even distinction is clearly related to the parity condition). A proof is valid if it meets the following conditions:
Consistency: For each q∈Q,[φ_{q} [symbol] (∃k:(ρ_{q}=k))](ρ_{q} is defined for every state in φ_{q})
Initiality: [I= [symbol] φ_{\hat{q}}] (every initial state satisfies the initial invariant)
Invariance and Progress: For each q∈Q, and predicate l over AP, based on the form of δ(q,l), check the following:
   tt: there is nothing to check.
   ff [φ_{q} [symbol] [symbol] l] holds,
   q₁\hat{ }q₂:[φ_{q}\hat{ }l\hat{ }(ρ_{q}=k) [symbol] (φ_{q1}(ρ_{q1} [symbol] _{q}k))\hat{ }(φ_{q2}\hat{ }(ρ_{q2} [symbol] _{q}k))]
   q₁ [symbol] q₂:[φ_{q}\hat{ }l\hat{ }(ρ_{q}=k) [symbol] (φ_{q1}\hat{ }(ρ_{q1} [symbol] _{q}k))\hat{ }(φ_{q2} [symbol] (ρ_{q2} [symbol] _{q}k))]
   [symbol] a [symbol] q₁:[φ_{q}\hat{ }l\hat{ }(ρ_{q}=k) [symbol] [symbol] a [symbol] (φ_{q1}\hat{ }(ρ_{q1} [symbol] _{q}k))]
   [a]q₁:[φ_{q}\hat{ }l\hat{ }(ρ_{q}=k) [symbol] [a](φ_{q1}\hat{ }(ρ_{q1} [symbol] _{q}k))]

It can be shown (Theorem 1) that for program M and automaton A, M [symbol] A if and only if there is a valid deductive proof that M satisfies A. It can be further shown (Theorem 2) that if \overline{M×A} is feasible, there is a valid deductive proof that M satisfies A. Theorem 2 gives valuable information about the constructed proof II if \overline{M×A} is finite-state:
(Uniform OR Choice) By the ∀∃ nature of the abstraction at OR states, for q such that δ(q,true)=q₁ [symbol] q₂, if (t, q) has a transition to (t′,q₁), then for every s such that sξ_{q}t holds, there is a transition from (s, q) to (s qᵢ). A similar observation holds for the [symbol] a [symbol] case.
(Bounded Progress) As the abstract ATS is finite-state, the rank domain W is a finite set. Thus, II shows that M satisfies A using only bounded progress measures.

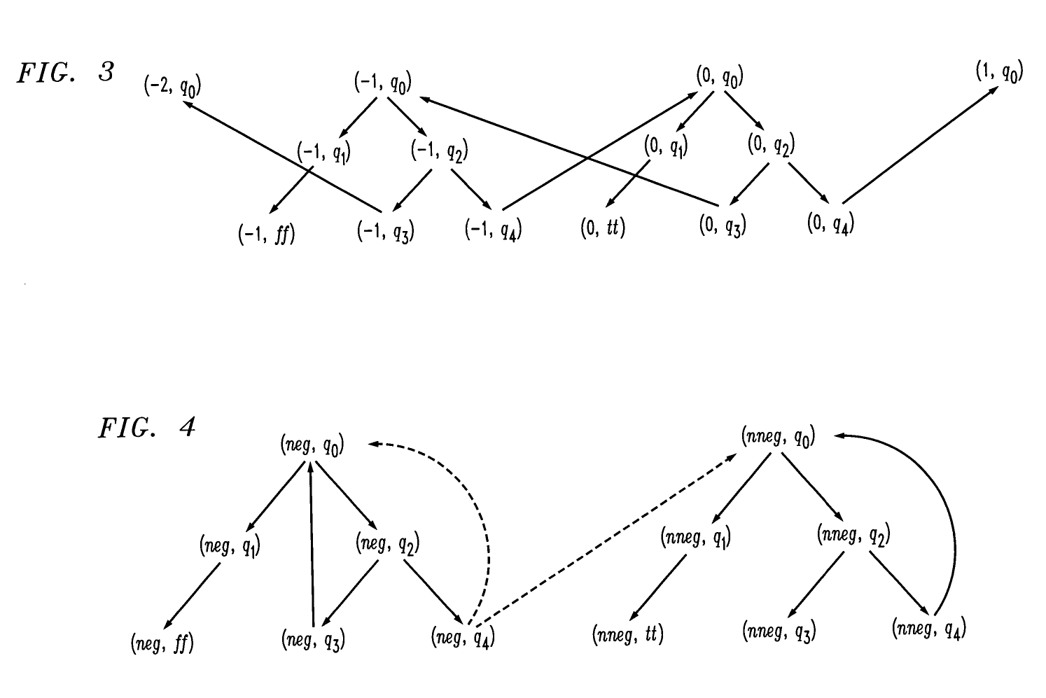

These restrictions mean that the program abstraction method 200, although sound, cannot be complete. To illustrate this, consider showing the branching time property EF (x≧0) (i.e., there exists a future where x≧0) for the following program M:
var x: integer; initially true
actions (a)x:=x−1(b)x:=x+1
   The property is true at every initial state, but showing this requires a proof with unbounded progress measure (the measure ρ(x)=−x, if x<0, else 0.) The automaton A for the property is defined below, and a fragment of the product ATS is shown in FIG. 3. FIG. 3 illustrates a number of states of a given program, M, where:
States: {q₀,q₂,q₃,q₄};
Initial state: q₀;
Transitions: δ(q₀, true)=q₁ [symbol] q₂;δ(q₁,x≧0)=tt, δ(q₁,x<0)=ff;
δ(q₂,true)=q₃ [symbol] q₄;δ(q₃, true)= [symbol] a [symbol] q₀;δ(q₄, true)= [symbol] b [symbol] q₀;
Parity condition: ({q₁}, {q₀, q₂, q₃, q₄}).

FIG. 4 illustrates an abstract ATS of the program, M, in FIG. 3. In particular, FIG. 4 illustrates the abstract domain where the negative and non-negative numbers of FIG. 3 are abstracted to two values in the abstract domain. Here, neg stands for {x|x<0)} and nneg stands for {x|(x≧0)}. Solid lines in FIG. 4 indicate transitions that are in the precise abstraction. However, these transitions, in themselves, are not sufficient for feasibility since there is no way to pick transitions so that it is possible to satisfy the acceptance condition from the abstract state ( neg,q0). The dashed transitions from state (neg,q₄) should exist in the abstraction, but these are ruled out by the strong ∀∃ nature of the abstraction at OR states. Clearly, it is not possible for all states where x<0 to have a b-transition to a state where x<0, and similarly, it is not possible for all such states to have a b-transition to a state where x≧0. On the other hand, the ∀∃ abstraction is needed for soundness at OR states. Moreover, no finite refinement of the neg state will resolve this problem.

Choice Predicates and Rank Functions

A way out of this dilemma is given by the introduction of choice predicates. The essential idea is to weaken the ∀ quantification at an abstract OR state (t,q) in the ∀∃ abstraction to apply only to a subset of the states in ξ_{q}⁻¹(t). These subsets are supplied to the abstraction procedure through a partial function ∈, defined for a subset of OR-states, called the choice states in the sequel. At each choice state (t,q), the finction supplies, for a possible transition to a state (t′,q′), a predicate ∈((t,q),(t′,q′)) (note that the transition is possible if either ε(q,true)=q₁ [symbol] q₂, and q′∈{q₁,q₂}, or δ(q,true)= [symbol] a [symbol] q₁ and q′=q₁). An abstract transition ((t,q),(t′,q′)) from a choice state (t,q) is computed by restricting the ∀ quantification in the ∀∃ abstraction to states satisfying its choice predicate. The union of choice predicates for all transitions in R′ from (t, q) should be a superset of ξ_{q}⁻¹(t).

At (neg, q₄), the choice predicate for the transition to (neg,q₀) is (x<−1), and the predicate for the transition to (nneg,q₀) is (x=−1). This adds back the dashed transitions in FIG. 4. However, it also creates a different problem. The transition from (neg,q₀)to (neg,q₄)introduces an infinite loop, which does not exist in the original ATS, since this transition increments the value of x. To solve this difficulty, we use rank functions in a manner similar to that in T. E. Uribe, “Abstraction-Based Deductive-Algorithmic Verification of Reactive Systems,” PhD Thesis, Stanford University, (1999); or Y. Kesten and A. Pnueli, “Verification by Augmented Finitary Abstraction,” Information and Computation, 163(1) (2000), each incorporated by reference herein.

Abstract Transition Relation Using Rank Functions and Choice Predicates

It is assumed that a set of rank functions {η_{q}|q∈Q} is supplied, that map states in S to a well-founded set with the structure specified in the proof system. A label (‘good’ or ‘bad’) is added to each abstract transition indicating whether the rank given by η changes in a way appropriate to the change of automaton state along the transition. The final method, for the supplied abstraction relations {ξ_{q}}, rank functions {η_{q}}, and the choice function ∈ is given below. The abstract ATS is given by (S′,I′,R′,L′)), where S′, I′, and L′are defined as before. The definition of the abstract transition relation, R′, is modified to the following, where g is the label on the abstract transition.

For an abstract AND state (t, q),
R′((t, q),g,(t′, q′)) [symbol] (∃s:sξ_{q}t:(∃s′:s′ξ_{q′}t′:R((s,q),(s′,q′))\hat{ }g≡η_{q′}(s′) [symbol] _{q}η_{q}(s)))

For an abstract choice state (t, q),
R′((t,q),g,(t′,q′)) [symbol] ∈((t,q),(t′,q′)≠0\hat{ }(∀s:sξ_{q}t\hat{ }s∈∈((t,q),(t,q′)):(∃s′:s′ξ_{q′}t′:R((s,q),(s′,q′))\hat{ }g≡η_{q′}(s′) [symbol] _{q}η_{q}(s)))
The transitions from abstract OR states are as for choice states with choice predicate ∈≡true.

A model check can be performed to determine whether player I has a winning strategy in \overline{M×A} with accepting condition: either the automaton accepts or from some point on, g is true. In the game, player II plays at AND and CHOICE states.

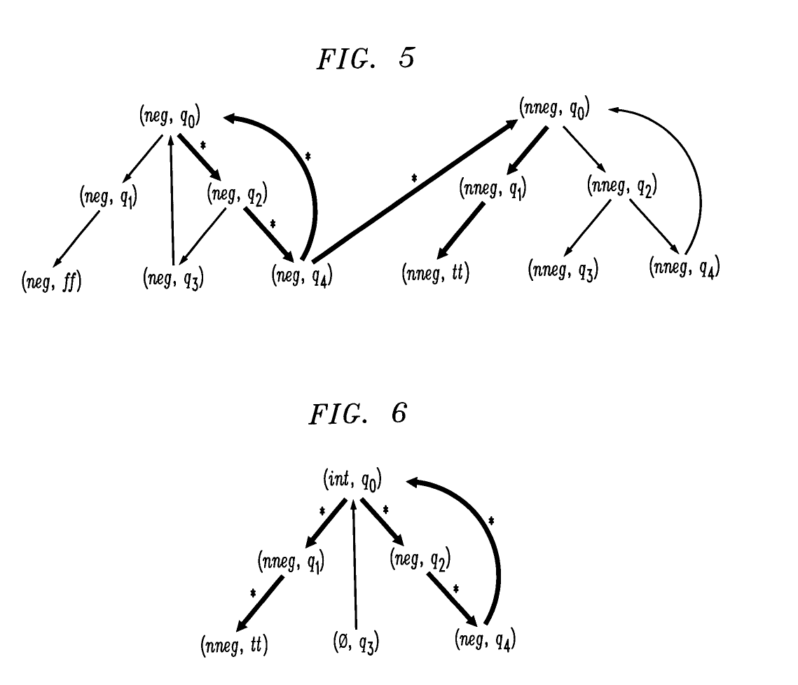

Taking, in addition to the choice augmentation discussed above, the rank functions where for s such that x(s)<0, η_{q}_{₀}(s)=−3*x(s); η_{q}_{₁}(s)=−3*x(s)−1, η_{q}_{₂}(s)=−3*x(s)−2, and for x(s)≧0, all values are 0, and applying the augmented abstraction procedure, the abstract ATS shown in FIG. 5 is obtained, where η-good transitions are labeled with *.

Only abstract ATS's are considered where at a choice state (t, q), the union of the choice predicates on its successors together form a superset of ξ_{q}⁻¹(t). A game is defined on such abstract ATS which is identical to the game defined above by Emerson and Jutla, except that: (a) player II has the choice of successor at every choice state, and (b) all infinite plays satisfy either the parity acceptance condition of the automaton or, from some point on, contain only η-good transitions. An abstract ATS is subtly feasible if player I has a winning strategy in the new game. The bold transitions in FIG. 5 indicate such a winning strategy.

It can be shown (Theorem 3 (Soundness of Augmented Abstraction)) that for any LTS M and alternating tree automaton A, let \overline{M×A} be defined by the augmented abstraction procedure above, based on a set of abstraction relations {ξ_{q}}, choice predicate ∈, and rank functions {η_{q}}. If \overline{M×A} is subtly feasible, then M×A is feasible.

Completeness

It can be shown (Theorem 4 (Completeness)) that if M satisfies an ATA property A, there is an augmented abstraction \overline{M×A} that is subtly feasible. The abstract ATS constructed in this manner for the example program is given in FIG. 6, with the winning strategy outlined in bold (i.e., thicker point size for arrows) (int stands for the set of all integers). This uses the same rank functions as for FIG. 5, and invariants defined by the abstract state component.

Predicate Abstraction

Predicate abstraction defines the abstract state space in terms of boolean variables corresponding to concrete program predicates. Computing a relevant set of predicates is impossible in general; however, there are several heuristics for predicate discovery. The general predicate discovery scheme] starts with a set P₀ of predicates from the correctness property, and iteratively computes Pᵢ₊₁ by adding the predicates in the weakest precondition wp of Pᵢ to Pᵢ. The limit of this procedure is denoted by the set P*.

From a modification of the main completeness theorem, the reverse direction of the following theorem can be derived. It is noted that the forward direction holds from the first soundness theorem. Thus, an exact characterization of the completeness of predicate discovery methods is obtained.

It can be shown that (Theorem 5 (Relative Completeness of Predicate Discovery)) for an LTS M and ATA A, predicate discovery coupled with abstraction produces a feasible result if and only if there is a proof that M satisfies A where the invariants in the proof are constructed from predicates in P*, the progress ranks are bounded, and the OR choices are uniform.

In T. Ball et al, “Relative Completeness of Abstraction Refinement for Software Model Checking,” TACAS, No. 2280 in Lecture Notes in Computer Science (LNCS) (2002), incorporated by reference herein, the authors show completeness of predicate discovery for invariance properties (i.e., AG(p)) relative to an oracle which can widen intermediate results of the xpoint computation of Φ=EF( [symbol] p), by dropping some conjunctive tenns. Notice that the widened fixpoint, Φ+, is defined in terms of predicates from P*, and [symbol] (Φ+) is an inductive invariant implying AG(p). Thus, a generalization of their result including existential and progress properties can be derived from these observations and Theorem 5. This method of proof also shows that the result holds for more powerful “clairvoyant” oracles, which may perform widening using predicates in P* that do not appear at the current stage.

It can be shown (Theorem 6 (Bisimulation and Finite-state Completeness)) that if LTS M has a finite bisimulation quotient preserving the predicates, AP, in a property A, then predicate discovery coupled with abstraction produces a feasible result.

Among other applications, the abstraction process can construct a mechanically-checkable proof of correctness (that M satisfies property f) after the final model checking step succeeds.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

In particular, the program abstraction method 200 may be implemented, for example, on a work station or computer (not shown) operated by a circuit designer or tester. The work station or computer includes a processor and memory to implement the methods described herein.

It is to be understood that the embodiments and variations shown and described herein are merely illustrative of the principles of this invention and that various modifications may be implemented by those skilled in the art without departing from the scope and spirit of the invention.

1. A method for reducing a program, M, that preserves at least one branching time property, f, comprising the steps of:
forming a product of said program, M and said branching time property, f, expressed as an automaton, f;
obtaining an abstract domain containing a set of abstract values to generalize possible states of said program and abstract relations that relate said program states to said abstract domain;
computing an abstract program with a reduced number of states and an altered version of said branching time property, f, using said product.

2. The method of claim 1, further comprising the step of performing an automated program check.

3. The method of claim 2, wherein said automated program check is a model checking step.

4. The method of claim 3, wherein said automated program check is performed for an altered branching time property.

5. The method of claim 1, wherein said computing step further comprises the step of defining a set of states, S′, in said abstract program as S′=\overline{S}×Q, where S is a set of states in said program, M, and Q is a finite set of states.

6. The method of claim 5, wherein OR states in said set of states, S′, are those states where δ(q,true) has the form q₁\hat{ }q₂ or [symbol] a [symbol] q₁, and all other states are AND states, where q are individual states and δ is a transition relation between states.

7. The method of claim 5, wherein an abstract state (t, \hat{q}) is in a subset of initial states, I′, of the abstract program if there exists s∈I for which sξ_{\hat{q}}t, where s is an individual state, I is a subset of initial states, I, of the program, M, and ξ_{\hat{q}} is one of said abstract relations.

8. The method of claim 5, wherein for an abstract AND state (t, q), the transition ((t, q); (t′,q′)) is in an abstract transition relation, R′, if there exists a concrete state (s, q) and a successor (s′,q′) that are related to (t, q); (t′,q′) respectively.

9. The method of claim 5, wherein for an abstract OR state (t, q), the transition ((t, q); (t′,q′)) is in an abstract transition relation, R′, only if for every (s, q) which is related to (t, q), there exists a successor (s′, q′) which is related to (t′, q′).

10. The method of claim 8, wherein said product ATS M×A is abstracted by weakening said transition relations at AND states.

11. The method of claim 9, wherein said product ATS M×A is abstracted by strengthening said transition relations at OR states.

12. The method of claim 8, further comprising the step of obtaining one or more rank functions and employing said one or more rank functions in an abstract transition relation, R′.

13. The method of claim 8, further comprising the step of obtaining one or more choice predicates and employing said one or more rank functions in an abstract transition relation, R′.

14. A system for reducing a program, M, that preserves at least one branching time property, f, comprising:
a memory; and
a processor operatively coupled to said memory, said processor configured to:
form a product of said program and said branching time property;
obtain an abstract domain containing a set of abstract values to generalize possible states of said program and abstract relations that relate said program states to said abstract domain;
compute an abstract program with a reduced number of states and an altered version of said branching time property using said product.

15. The system of claim 14, wherein said processor is further configured to perform an automated program check.

16. The system of claim 15, wherein said automated program check is a model checking step.,

17. The system of claim 16, wherein said automated program check is performed for an altered branching time property.

18. The system of claim 14, wherein said processor is further configured to define a set of states, S′, in said abstract program as S′\overline{S}×Q, where S is a set of states in said program, M, and Q is a finite set of states.

19. The system of claim 18, wherein OR states in said set of states, S′, are those states where δ(q,true) has the form q₁ [symbol] q₂ or [symbol] a [symbol] q₁, and all other states are AND states, where q are individual states and δ is a transition relation between states.

20. The system of claim 18, wherein an abstract state (t,\hat{q}) is in a subset of initial states, I′, of the abstract program if there exists s∈I for which sξ_{\hat{q}}t, where s is an individual state, I is a subset of initial states, I, of the program, M, and ξ_{\hat{q}} is one of said abstract relations.

21. The system of claim 18, wherein for an abstract AND state (t, q), the transition ((t, q); (t′,q′)) is in an abstract transition relation, R′, if there exists a concrete state (s, q) and a successor (s′,q′) that are related to (t, q); (t′,q′) respectively.

22. The system of claim 18, wherein for an abstract OR state (t, q), the transition ((t, q); (t′,q′)) is in an abstract transition relation, R′, only if for every (s, q) which is related to (t, q), there exists a successor (s′, q′) which is related to (t′, q′).

23. The system of claim 21, wherein said product ATS M×A is abstracted by weakening said transition relations at AND states.

24. The system of claim 22, wherein said product ATS M×A is abstracted by strengthening said transition relations at OR states.

25. The system of claim 21, further comprising the step of obtaining one or more rank functions and employing said one or more rank functions in an abstract transition relation, R′.

26. The system of claim 21, further comprising the step of obtaining one or more choice predicates and employing said one or more rank functions in an abstract transition relation, R′.
